(19) United States
(12) Patent Application Publication
(10) Pub. No.: US 2017/0314938 A1
(43) Pub. Date: Nov. 2, 2017

(54) METHOD AND DEVICE FOR REAL-TIME ERROR-BOUNDED AND DELAY-BOUNDED MAP MATCHING

(71) Applicant: National University of Singapore, Singapore (SG)

(72) Inventors: Guanfeng Wang, Singapore (SG); Roger Zimmermann, Singapore (SG)

(21) Appl. No.: 15/522,736

(22) PCT Filed: Oct. 28, 2015
(86) PCT No.: PCT/SG2015/050419

§ 371 Date: Apr. 27, 2017

(30) Foreign Application Priority Data
Oct. 28, 2014 (SG) 10201407014T

(51) Int. Cl. G01C 21/32; G06N 7/00

(52) U.S. Cl. CPC G01C 21/32; G06N 7/005

(57) ABSTRACT

Method and device for real-time error bounded and relay bounded map matching. The method for map matching comprises of modelling each road arc as a hidden state and each location measurement as an observation emitted by the hidden state using a Hidden Markov Model, decoding each road arc and each location measurement using a Viterbi algorithm and outputting a matching road arc, wherein the outputting is delayed by a delay time in response to an optimal trade-off between selection accuracy and selection latency.

### PRIORITY CLAIM

This application claims priority from Singapore Patent Application No. 10201407014T filed on Oct. 28, 2014.

### FIELD OF INVENTION

This embodiment broadly relates to a map matching method and a map matching device and in particular, relates to a map matching method and a map matching device using Hidden Markov Models and Viterbi algorithms.

### BACKGROUND TO THE INVENTION

Recently, there is increasing need for real-time positioning data that is driven by the availability of localization sensors attached to moving objects such as vehicles and pedestrians. This type of data can be continuously acquired and effectively utilized by a broad range of applications. Locations can not only provide a pair of longitude/latitude coordinates, but can also indicate the spatial context of the moving objects or mobile devices if a surrounding geographic information database is available. Systems including Geographic Information System (GIS), Intelligent Transportation System (ITS) and Location-based Services (LBS) have widely employed such context to a plurality of uses which include customizing profile settings and optimizing complex operations. To better interpret these useful contexts, a map matching method that integrates the positioning data (from GPS or other sensors) with the spatial road network data can play a fundamental role.

The input of a typical map matching method is a temporal sequence of location points, i.e., a trajectory. In practice, most raw location information provided from sensors may not be highly accurate or not easily interpretable due to reasons such as inherent errors and noise generated by the localization sensors and the sampling methods employed by the embedded systems. Generally, GPS can offer good accuracy to the level of around 10 meters and is available worldwide. Other techniques may be feasible in urban environments, but their accuracy can deteriorate in rural areas. Although the standard deviation of GPS location inaccuracy can be quite low, serious deviations can be observed due to varying surrounding environmental conditions such as tree cover and high buildings. In addition, the use of low-cost, consumer-grade sensors in current mobile devices or vehicles can be another inevitable reason for accuracy degradation. Therefore, a map matching method can be advantageous to help improve the positioning accuracy if the respective digital map is reliable, and to associate the coordinates with the surrounding spatial entities seamlessly.

In the context of Markov information sources and Hidden Markov models, the Viterbi method, a dynamic programming method, is widely used for decoding such models. This method can find the most likely sequence of hidden states for a given observation sequence. It can compute a forward pass over the input sequence to compute probabilities, followed by a reverse pass to compute the optimal state sequence. Therefore, all the data must be obtained before any of the hidden states can be inferred. The result of the underlying state chain is called a Viterbi path. However, when applied to a real-time or an interactive system, one noticeable disadvantage of the Viterbi method is that the optimal state sequence cannot be computed until the entire input has been observed.

For latency-sensitive applications such as route navigation and traffic incident detection, it is unacceptable to receive map matching results after the whole itinerary is finished. In Hidden Markov Model based map matching, the key input and output of a traditional Viterbi decoder are the location observations (e.g., GPS measurements) and the most likely road trajectory of a moving object. Conceptually, the input observation stream could be extremely long, or even infinite, which leads to a significantly longer latency than a timely response that systems may require. Therefore, the traditional Viterbi decoder is not suited for real-time applications where there are strong latency constraints. In view of the real-time decoding issue of the Hidden Markov model, one conventional method proposes utilizing Hidden Markov models with a variable sliding window scheme to provide an online solution but the delay bound of road arc generation is not be guaranteed.

Conversely, accuracy can also be another crucial factor for most location-based applications. To shorten the mapping delay, a system can have the freedom to match raw location measurements greedily, mapping each sample immediately as an extreme case, without waiting for enough future observations. However, it can be undesirable to give up the accuracy increase gained by map matching techniques or even worse, pick an incorrect road path as output. The risk of selecting a false road may cause serious issues in real systems such as incident detection. Any inaccurate output may also raise the expected monetary cost in some enterprise services, e.g. logistics truck monitoring and fleet scheduling.

Thus, what is needed is a method and device for map matching to provide an optimal solution to minimize the trade-off between selection latency and selection accuracy for its output. Furthermore, other desirable features and characteristics will become apparent from the subsequent detailed description and the appended claims, taken in conjunction with the accompanying drawings and this background of the disclosure.

### SUMMARY OF THE INVENTION

In accordance with one aspect of the present embodiments, a method for map matching is disclosed. The map matching method includes modelling each road arc as a hidden state and each location measurement as an observation emitted by the hidden state using a Hidden Markov Model, decoding each road arc and each location measurement using a Viterbi method, and outputting a matching road arc. The outputting is delayed by a delay time determined in response to an optimal trade-off between selection accuracy and selection latency.

In accordance with another aspect of the present embodiments, a device for map matching is disclosed. The map matching device includes a location data receiving device, a memory having road arcs in a road network stored therein, a user interface including a user presentation device and a processor coupled to the location data receiving device, the memory, and the user interface. The processor is configured to model each of the road arcs stored in the memory as a hidden state and each location measurement detected by the GPS receiver as an observation emitted by the hidden state using a Hidden Markov Model, decode each road arc and each location measurement using a Viterbi method and output a matching road arc to the user presentation device, the output being delayed by a delay time determined in response to an optimal trade-off between selection accuracy and selection latency.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present embodiment, by way of non-limiting example only.

Embodiments of the invention are described hereinafter with reference to the following drawings, in which:

FIG. 1 is an illustration depicting an example of a map matching problem in accordance with a present embodiment.

FIG. 2 is a block diagram of a map matching device in accordance with the present embodiment.

FIG. 3, comprising FIGS. 3A-3B, are illustrations depicting the functions of the map matching method and their corresponding relationships, in accordance with a present embodiment, wherein FIG. 3A depicts a system overview of the said map matching method and FIG. 3B depicts a functional flow chart of the said map matching method.

FIG. 4 is a diagram depicting a state transition flow and Viterbi decoding method in accordance with the present embodiment.

FIG. 5 is an example of an improved online Viterbi Decoding method for general cases in accordance with the present embodiments.

FIG. 6 is a graph depicting example trends of information entropy of location measurements as time elapses in accordance with the present embodiment.

FIG. 7, comprising FIGS. 7A-7F, are graphs depicting examples of the accuracies and latencies in accordance with the present embodiment with different location measurement sampling intervals, wherein FIG. 7A depicts a sampling interval of one observation sample per second, FIG. 7B depicts a sampling interval of one observation sample for every two seconds, FIG. 7C depicts a sampling interval of one observation sample for every three seconds, FIG. 7D depicts a sampling interval of one observation sample for every five seconds, FIG. 7E depicts a sampling interval of one observation sample for every ten seconds and FIG. 7F depicts a sampling interval of one observation sample for every fifteen seconds.

FIG. 8, comprising FIGS. 8A-8B, are graphs depicting examples of accuracies in accordance with the present embodiment with different location measurement sampling intervals wherein FIG. 8A depicts measurement sampling intervals under fixed latency constraints of ten seconds and FIG. 8B depicts measurement sampling intervals under fixed latency constraints of fifteen seconds.

Skilled artisan will appreciate that elements in the figures are illustrated for simplicity and clarity and have not necessarily been depicted to scale.

### DETAILED DESCRIPTION

The following detailed description is merely exemplary in nature and is not intended to limit the embodiments or the application and uses of the embodiments. Furthermore, there is no intention to be bound by any theory presented in the preceding background of the embodiments or the following detailed description. It is the intent of this embodiment to present a map matching method which utilizes an optimal solid error and delay-bound trade-off analysis using a Hidden Markov Model in conjunction with a Viterbi decoding method.

As used herein unless the context otherwise requires, a road network G(V, E) represents a finite street system which consists of a set of one way or two-way road curves, called road arcs, in two-dimensional Euclidean space. Each road arc eᵢ(eᵢεE) is assumed to be piecewise linear and is characterized by a finite sequence of points Aⁱ=(a₁ⁱ, a₂ⁱ, . . . , aₘⁱ). The end points a₁ⁱ and aₘⁱ are nodes belonging to a vertex set V. Other points in the middle are referred to as shape points and each road arc, eᵢ, has properties such as speed constraints.

A location trajectory L={l₁, l₂, . . . , lₙ} is a sequence of location measurements from localization sensors according to a time sequence, T={t₁, t₂, . . . tₙ}. Each location measurement lᵢ includes longitude coordinates xᵢ and latitude coordinates γᵢ. The ground truth of the position sequence data can be denoted as G₁={t₁, t₂, . . . , tₙ} and their associated road arcs Gₑ={γ₁, γ₂, . . . , γₙ}, GₑεE. The match point mᵢ^{j} of a location measurement sample point lᵢ on a road arc eⱼ is a point

$${m}_{i}^{j} = {argmin}_{∀ {m}_{k}^{j} ∈ {A}^{j}} dist ( {m}_{k}^{j} , {l}_{i} ) ,$$

where dist(mₖ^{j}, lᵢ) provides the great circle distance between lᵢ and any point on A^{j}, including end points and shape points.

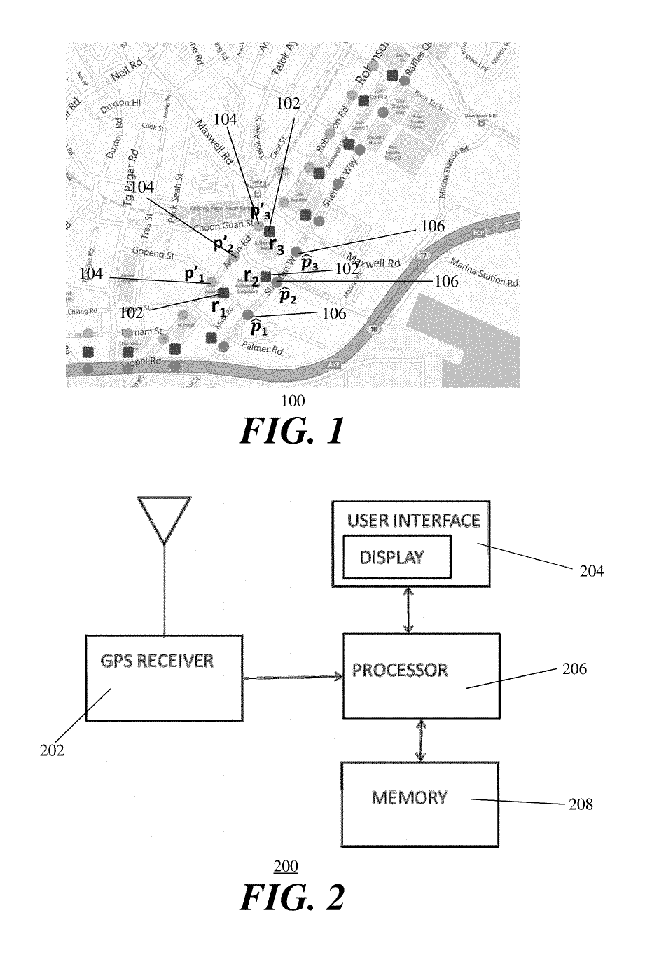

Referring to FIG. 1, an illustration 100 depicts an example of a map matching problem in accordance with the present embodiment. The dots 102 including r1, r2 and r3 are measured raw location coordinates. The task of map matching is to find a true road that a moving object is on. However, it can be a challenging problem since either the trajectory represented as points including p₁′, p₂′ and p₃′ 104 or the trajectory represented as points including \hat{p}₁, \hat{p}₂ and \hat{p}₃ 106 can be the actual driving path and it is difficult to determine by only analysing separate samples. Without prejudice to the generality of the foregoing, the present embodiment seeks to solve the problem as follows: given a network G(V,E), and trajectory information L and T, the present embodiment seeks to find a most likely path P={p₁, p₂, . . . , pₙ}, where αₘⁱ⁻¹=a₁ⁱ and P⊂E, where P is a subset of connected road arcs from G, along with each pᵢ's mapping output time T′={t₁′, t₂′, . . . , tₙ′}.

Referring to FIG. 2, a block diagram 200 of an exemplary device for map matching in accordance with the present embodiment may be used to facilitate execution of the above-described method for map matching. The exemplary device includes a processor 206 being configured to carry out the functions of the flowchart 326 and coupled to a GPS receiver 202 or any similar location data receiving device, a memory device 208 and a user interface 204. Although a single processor is shown for the sake of clarity, the device may also include a multi-processor system. The GPS receiver 202, hereinafter interchangeably referred to as a location receiving device 202, is coupled to the processor 206 to provide location data thereto. The location receiving device 202 is capable of producing location measurement points which may be in the form of coordinate points that can include latitude/longitude coordinates. The location receiving device 202 also includes at least one location sensor and at least one communication input/output for communicating with the processor 206. The location receiving device 202 may also include devices for processing, memory storage or display. The memory 208 may include a single or a plurality of volatile or non-volatile memory devices and can be used to store data from the processor or any predetermined data which can include road arcs in a road network. As shown in the diagram 200, the device also includes a display interface 204 which performs operations for rendering images to an associated display and/or provides a form of user interaction with the map matching device.

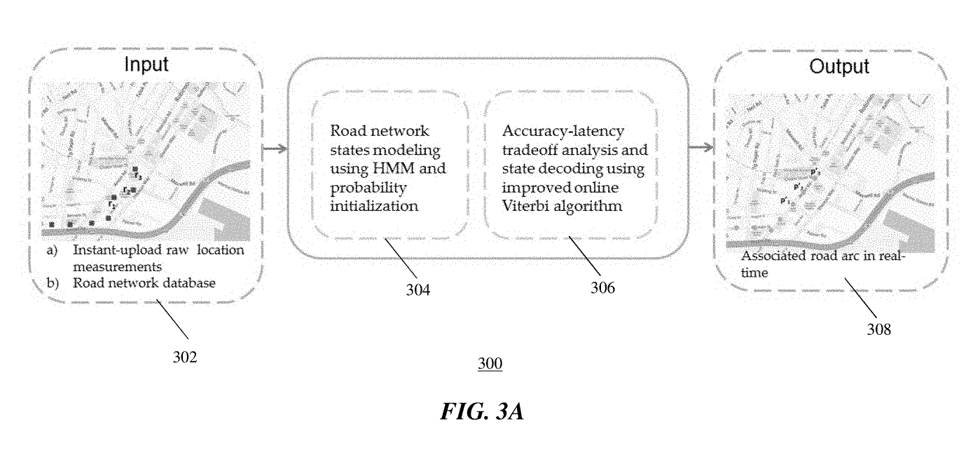

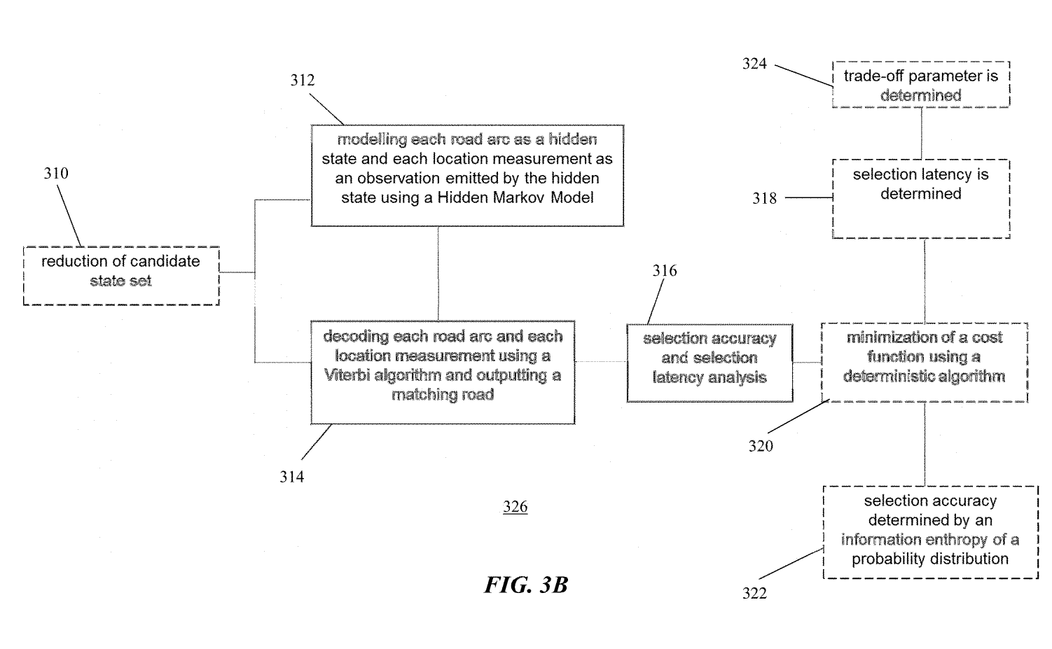

Referring to FIG. 3, comprising FIGS. 3A-3B, are illustrations depicting the functions of the map matching method and their corresponding relationships, in accordance with a present embodiment, wherein FIG. 3A depicts a system overview of the said map matching method and FIG. 3B depicts a functional flow chart of the said map matching method. The map matching method as depicted in FIG. 3 may be performed by a device which is described with reference to FIG. 2. As seen in FIG. 3A, the system of the map matching method includes an input 302, functional modules 304 and 306 and an output 308. The input 302 includes location measurements and road network databases. The positioning data can be instantly uploaded since an application feature of the present embodiment includes latency applications and services. The output 308 can be a real time continuous output of road arcs. The road arcs can have bounded accuracy and latency levels. The functional modules 304, 306 of the map matching method in accordance with the present embodiment includes modelling of the road network state using Hidden Markov model 304 which has the benefit of coping with noisy environments and an online Viterbi decoding method 306 which, in accordance with the present embodiment, includes an improved accuracy-trade-off analysis feature. The flow of all functions of the map matching method is further elaborated by the flow chart 326.

As seen in FIG. 3B, the flow chart 326 of the map matching method according to the present embodiment provides an overview of the functional flow of the map matching method in accordance with the present embodiment. General functions of the map matching method modelling in accordance with a Hidden Markov Model 312 and decoding in accordance with an online Viterbi decoding method 314 which is modified in accordance with the present embodiment to improve a selection accuracy and selection latency trade-off analysis 316. To accelerate the processing, the set of candidate states, which includes road arcs, is first reduced 310. A radial search method is an exemplary means to reduce the set of candidate road arcs by finding the candidate road arcs of a location measurement. Thereafter, the hidden Markov Model 312 models a hidden state transition model of the road arcs, and an observation emitted by the hidden state of the location measurement. Simultaneously, the Viterbi decoding method 314 is used to discover the hidden sequence which is most likely to have a given observation sequence. The hidden sequence includes a road arc sequence that is most likely to produce the collected location measurements. A selection accuracy and selection latency trade-off analysis 316 is used in tandem with the Viterbi decoding method 314 for improvement of the accuracy and latency aspect of the output. Selection accuracy and selection latency trade-off can be optimized by minimizing a cost function 320 such that the output is delayed by a delay time in response to an optimal trade-off between selection accuracy and selection latency. In one implementation, the selection accuracy of the map matching problem can be modelled as a decreasing function of the output's delay time and the selection latency is an increasing function of delay time.

In accordance with the present embodiment, the selection latency and selection accuracy is initially determined. Selection accuracy 322 can be determined by information entropy of a probability distribution which includes the likelihood of each road arc being the matching road arc. For the selection latency to be determined, a trade-off parameter needs to be determined first 324. The selection latency is then determined by a function of the trade-off parameter and the delay time 318. The solution to this problem used at step 320 is accordingly based on a break-even algorithm which includes the output delay time being determined when the selection accuracy is equal to or less than the selection latency.

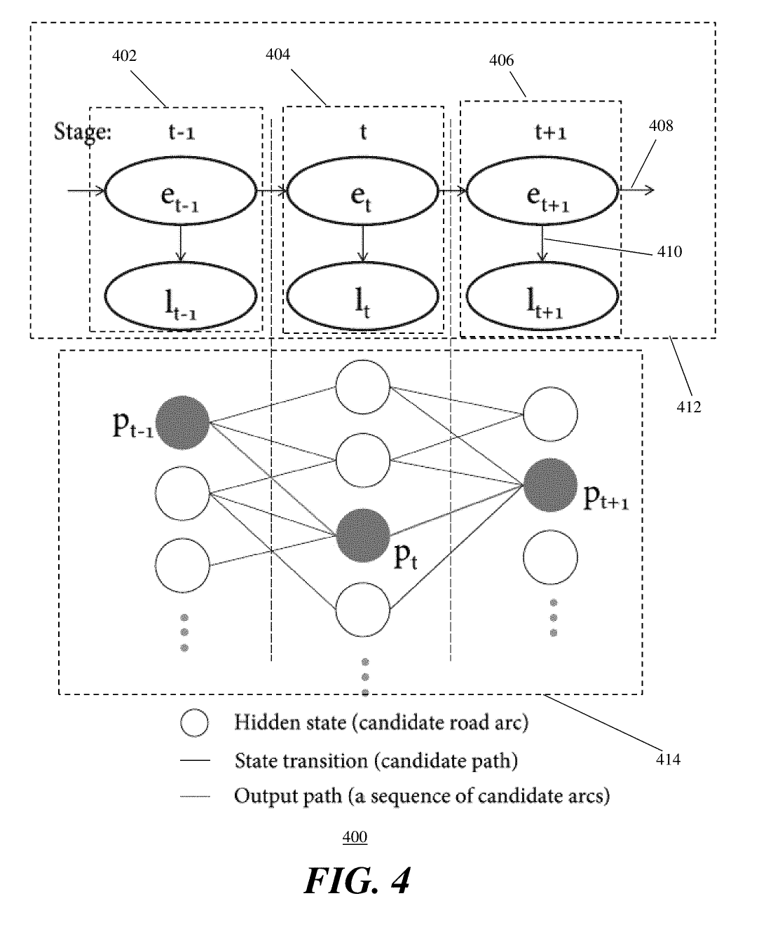

Referring to FIG. 4, an illustration 400 depicts a view of a state transition flow diagram 412 and a Viterbi decoding method in the form of a trellis diagram 414. With respect to the framework of a Hidden Markov Model, the road arc travelling problem can be presented as a hidden state transition model 404 whereby the random variables eₜ and lₜ are hidden and observation states at time t, respectively. Random variables eₜ₋₁, lₜ₋₁ 402 and eₜ₊₁, lₜ₊₁ 406 are hidden and observation states at one sampling time interval before time t and one sampling time interval after time t, respectively. Every road arc eᵢ can be modelled as a hidden state with each location measurement lₜ as an observation emitted by the hidden state. In the illustration 400, horizontal arrows 408 and vertical arrows 410 indicate two parameters in the model. The horizontal arrows 408 represent a transition probability between two consecutive hidden states. These transition probability arrows 408 quantify the likelihood that a vehicle is moving from road arc eₜ₋₁ to road arc eₜ to road eₜ₊₁. Each vertical arrow 410 represents an emission probability between the hidden state and the observation. The arrows 410 represent how likely the measurement lₜ can be observed if the vehicle is driving on a certain road arc.

The online Viterbi method is depicted in the form of a trellis diagram 414. The diagram depicts all possible paths, denoted by lines from one candidate road arc to another, each denoted by a circle. The shaded circles together with their connecting lines represent the most likely paths outputted from the online Viterbi decoding method denoted by pₜ, pₜ₊₁ and pₜ₋₁. During the decoding phase, candidate arc paths can be sequentially generated and evaluated on the basis of likelihoods. The online Viterbi decoding method is used to find the maximum likely path over a Markov chain that has the highest joint emission/transmission probability within the latency bounded map matching.

The map matching method can be modelled by transition, emission and initial probability as:

λ=( [symbol] , [symbol] ,π) (1)

The state set is E and the observation set is L. In the embodiments' model, the initial probability πᵢ of being in state eᵢ is defined as the emission probability at this state. The emission probability [symbol] (lₜ) of observation lₜ from state eᵢ is obtained by modeling the positioning measurement noise as a Gaussian distribution:

$${i}_{} ( {l}_{t} ) = ℙ ( {l}_{t} \vert {p}_{t} = {e}_{i} ) = \frac{1}{σ \sqrt{2 π}} {e}^{\frac{{dist ( {e}_{i} , {l}_{t} )}^{2}}{2 {σ}^{2}}} \qquad ( 2 )$$

where σ is the standard deviation of the positioning measurements. For example, when the input location observations are a sequence of GPS collected points, a standard deviation of ten meters can be used to estimate the noise distribution. The shortest distance from lₜ to the candidate road arc eᵢ is represented by dist(eᵢ,lₜ), which is the great circle distance on the surface of the earth between lₜ and its corresponding match point mₜⁱ.

The distance differences between the observation pairs and match point pairs can be utilized to estimate the transition probabilities. Given two measurements lₜ₋₁, lₜ and their match points mⁱₜ₋₁, mₜⁱ, the transition probability of moving from eᵢ to eⱼ can be represented as:

[symbol]

^{ij}= [symbol] (pₜ=eⱼ|pₜ₋₁=eᵢ)=βₑ^{-β∥d}^{ₗ}^{-d}^{ₘ}^{∥} (3)

where dₗ is the great circle distance between two location measurements and dₘ is the shortest route distance from mₜ₋₁ⁱ to mₜ^{j}.

Within a dynamic window size, the model can be later decoded by the online Viterbi decoding method resulting in output pₜ={eₖ, eₖ₊₁, . . . , eᵢ}, where {eₖ, eₖ₊₁, . . . } is the route path between eᵢ₋₁ and eᵢ and is determined by a selected state transition path. This subset of candidate road arcs is generated as the most likely path for given observation lₜ and guarantees that the output paths are connected. In the following description, the {eₖ, eₖ₊₁, . . . } part in equations is omitted while connecting paths in the real system are being tracked.

Decoding can be used to discover the hidden state sequence that is most likely to have produced a given observation sequence. In the context of map matching, the present embodiment finds the road arc sequence that is most likely to generate the collected location measurements. The traditional Viterbi decoder method is a trellis method defined as

δₜ(i)=maxₚ_{₁}ₚ_{₂}_{. . . p}_{_{t−1}} [symbol] {p₁,p₂, . . . ,p_{t-1,}pₜ=eᵢ,l₁,l₂, . . . ,lₜ−1|λ} (4)

and gives the highest probability that a partial observation sequence and state sequence up to time step t can have when the current state is i. The initialization and recursion step of the decoding phase are defined as:

δ₁(i)=πᵢ [symbol] ᵢ(l₁) (5)

δₜ(j)=max_{1≦i≦N}[δₜ₋₁(i) [symbol] ⁱⁱ] [symbol] ⱼ(lₜ) (6)

where N is the cardinality of candidate state set S, S∪E. It is common that the scale of the road network being modeled, card(E), is relatively large, which leads to inefficiencies in decoding. The present embodiment narrows down the set of candidate states within S to accelerate the processing.

At each time step, the probability distribution is normalized to ensure Σⱼ₌₁^{N}δₜ(j)=1. The backtracking pointer of the selected hidden state at each step is as follows:

$${ψ}_{t} ( j ) = {arg max}_{1 \leq i \leq N} [ {δ}_{t - 1} ( i ) {𝒯}_{t}^{ij} ] \qquad ( 7 )$$

The procedure conventionally terminates when the last observation is received and decoded, thereby permitting the optimal path to be obtained by backtracking from the last matching result:

$$\begin{matrix}{p}_{T} = arg {max}_{1 \leq i \leq N} [ {δ}_{T} ( i ) ] & ( 8 ) \\ {p}_{t} = {ψ}_{t + 1} ( {p}_{t + 1} ) & ( 9 )\end{matrix}$$

However, this conventional type of decoder is not suited for real-time systems since the optimal state sequence cannot be computed until the entire input has been observed. The tradeoff between the map matching accuracy and latency can be modelled by the online decoder as a ski-rental problem. In a ski rental problem, a skier may rent skis for R per day or buy them for B dollars. At the end of any day, the skier may break his legs along with the skis, or in some other way irrevocably finish skiing. The solution is to develop an online strategy minimizing the cost spent on skiing, where the cost is compared to the cost of an optimal offline strategy for the same input. The worst-case ratio between these two amounts is called a competitive ratio. The total cost of skiing, [symbol] ₛ is

[symbol]

ₛ=+B_{\hat{t}}+R×\hat{t} (10)

where the skier decides to buy the skis in the evening of the \hat{t}^{th} day.

The present embodiment adopts a generalized ski-rental problem model with an inconstant buying price Bₜ that changes over time. The present embodiment models the accuracy and latency penalty as the buying price and rental rate, respectively, to determine whether to remain in the current decoding state and pay a certain amount of latency cost per time, or output the present matching result and pay some large accuracy penalties but with no further delay penalty. Without loss of generality, the location observation l₀ measured at t₀ can be assumed to have matched the road network and l₁ from t₁ is currently under the decoding phase. Future information up to \hat{t} is observed and transferred to the Viterbi decoding function for joint probability computation of and lₓ and tₓ₁. The Viterbi decoder needs to decide whether to output the matched result p₁ at time \hat{t}. The delay of decoding l₁ is \hat{t}−t₁, which is similar to the rental rate that a skier has to pay before a buying decision. To better estimate the accuracy of the matching road arcs, the probability distribution δ_{t1,\hat{t}}(j) can be leveraged to indicate the likelihood of each state e₁ being the matching road arc. This is different from δₜ_{₁}(j) as the system in accordance with the present embodiment advantageously injects future information into the inference chain. The variable, δₜ_{₁}(j), can be calculated as follows, considering that the matching result p₀ for the observation l₀ has already been generated:

$$\begin{matrix}{δ}_{t 1} ( j ) = {max}_{1 \leq i \leq N} [ {δ}_{0} ( i ) {𝒯}_{t}^{ij} ] {j}_{} ( {l}_{1} ) & ( 11 ) \\ {δ}_{t 0} ( i ) = \{ \begin{matrix}1 , & if {p}_{0} ε {e}_{i} . \\ 0 , & otherwise .\end{matrix} & ( 12 )\end{matrix}$$

where the distribution of δₜₒ is determined. With all future observations from t₁ to \hat{t} present, therefore, it can then be obtained that:

δ_{t1,\hat{t}}(j)=Σᵢ₌₁^{N}δ_{\hat{t}}(i) (13)

if ψ_{t1,\hat{t}}(i)=j (14)

where ψ_{t1,\hat{t}}(i) is the backtracking function from time frame \hat{t} to t₁

ψ_{t1,\hat{t}}(i)=ψₜ₁(ψₜ₂( . . . ψ_{\hat{t}-2}(ψ_{\hat{t}-1}(i)))) (15)

Thus, ψ_{t1,\hat{t}} (i) is the sum of δ_{\hat{t}} (j) where eⱼ at time step tᵢ and eⱼ at time step \hat{t} are on the same candidate path connected by the Viterbi backtracking pointers. For each eⱼεS, δ_{t1,\hat{t}}(j) presents the probability that l₁ should be matched to eⱼ after future observations up to \hat{t} are factored into the Hidden Markov model.

If only one state is calculated with a significantly high probability and the other states' likelihoods are near zero, it can be deduced confidently that this state is the matching road and this road arc can be generated as the output label. To describe the distribution characteristics and incorporate this into the decoding procedure in accordance with the present embodiment, an information entropy of δ_{t1,\hat{t}}(j) represented as [symbol] (t₁, \hat{t}) can be used as a proxy of the accuracy penalty as follows:

[symbol]

(t₁,\hat{t})=−Σⱼ₌₁^{Nδ}_{t1,\hat{t}}(j)log δ_{t1,\hat{t}}(j) (16)

The entropy [symbol] (t₁, \hat{t}) is a logarithmic measurement of the number of states with significant probability of being occupied, which indicates the degree of uncertainty at time step t₁ after receiving future observations up to \hat{t}. In accordance with the definition of the entropy function, the larger the value [symbol] is, the higher the uncertainty of this outcome state can be. The highest entropy outcome can be achieved when δ_{t1,\hat{t}}(j) is evenly distributed among all candidate states. On the other hand, if [symbol] is close enough to zero, it means that one outcome state is certain within the candidate space. This plays the same role as the buying price Bₜ in the ski-rental model. Therefore, in accordance with the equation, [symbol] ₛ=B_{\hat{t}}+R×\hat{t}, the objective cost function can be derived as the sum of the accuracy penalties and delay penalties,

[symbol]

ₛ= [symbol] (t₁,\hat{t})+γ(\hat{t}−t₁) (17)

where γ is the parameter to control the trade-off between the accuracy gain and delay cost. If the real-time system is extremely sensitive to the latency, a larger value of γ can be chosen. Likewise, if the monetary cost of false road matching is expensive, a smaller γ can be considered to penalize the accuracy part.

Similar to using the ski-rental model to determine the buying date, a strategy in accordance with the present embodiment is formulated to decide at which \hat{t} the matching result arg maxⱼ[δ_{t1,\hat{t}}(j)] can be outputted without further delay. Thus, the online system needs to choose an appropriate label generation time \hat{t} to minimize the cost.

The delay cost can accumulate linearly like a monotonically increasing function. If the accuracy penalty [symbol] (t₁, \hat{t}) changes arbitrarily over time, its sum [symbol] can be difficult to minimize or even analyse. Thus an assumption can be made that given t₁, [symbol] is a monotonically decreasing function of variable \hat{t}. The physical meaning of this assumption is that it is likely the uncertainty of the state outcome at a certain time step would decrease as a growing number of future observations are analysed within the decoding procedure. Therefore, minimizing the sum of a decreasing function and an increasing function is needed. Similarly, while choosing the time point \hat{t} when [symbol] (t₁, \hat{t}) is equal or less than the value of γ(\hat{t}−t₁), the matching road is outputted. This algorithm is used to adaptively adjust the window size based on the uncertainty of the state matching. If the uncertainty degree is high, the algorithm should extend the window size to absorb more future location observations before generating the road arc label. Conversely, if the initial [symbol] value is low enough or the function [symbol] drops rapidly, the window can become smaller and the matching output can be generated sooner.

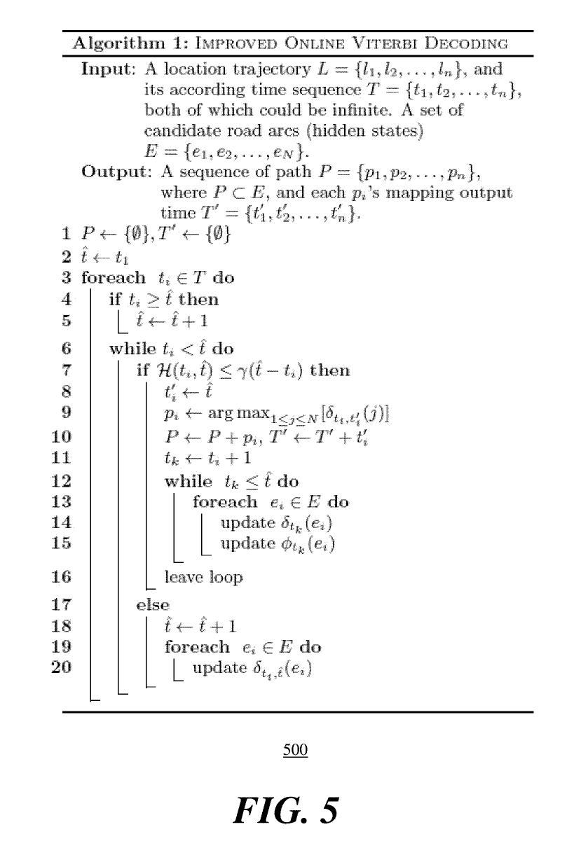

FIG. 5 is a pseudo code example 500 of the improved online Viterbi Decoding method in accordance with the present embodiment for general cases. The “+” operator on line 10 adds a new output to the global sequence. P and T′ can be implemented as a pipe with capacity of 1, so that once a new output pᵢ is generated, it can be consumed by an upstream real-time application immediately, and the latency is tᵢ′−tᵢ.

To better illustrate the advantage of the improved online decoding algorithm in accordance with the present embodiment, a theoretical competitive and upper-bound analysis can be presented for accuracy and latency, respectively. The competitive ratio of the decoder in accordance with the present embodiment determines the worst-case ratio between the cost of the solution found by the online decoding algorithm and the cost introduced by an optimal solution. Assume for a given lᵢ received at tᵢ, the present method generates a respective road arc label at time t. Two situations need to be considered when analysing the worst case: the actual optimal output time step Tₒ<t and Tₒ>t. The cost of the optimal solution is represented as [symbol] (tᵢ,T₀)+γ(T₀−tᵢ). If Tₒ<t, even with more measurements adopted, the cost decrease due to the accuracy penalty [symbol] does not make up for the cost increase caused by the latency penalty. In other words, the concentration expectation of the state distribution based on future observations cannot be achieved. The worst case is when [symbol] (tᵢ, tᵢ)= [symbol] (tᵢ, t)+ε where ε is a real number approaching zero for which ε cannot be zero since [symbol] is a monotonically decreasing function, and the optimal output is T₀=Tᵢ. The optimal solution can output the map matching result immediately since future observations do not influence the decoding process for achieving no latency penalty due to the cost function,

[symbol]

(tᵢ,T₀)= [symbol] (tᵢ,tᵢ)= [symbol] (tᵢ,tᵢ) (18)

Since the present method can generate a road arc result at t and not t−1, hence,

[symbol]

(tᵢ,t)<γ(t−tᵢ) (19)

[symbol]

(tᵢ,t−1)>γ(t−1−tᵢ) (20)

In addition, [symbol] (tᵢ, t)− [symbol] (tᵢ, t−1)<ε<γ, and, therefore, it can then be obtained that

γ(t−1−tᵢ)< [symbol] (tᵢ,t)< [symbol] (tᵢ,tᵢ) (21)

Thus, the cost function of the method in according to the embodiments is

$$\begin{matrix}𝒞 ( {t}_{i} , t ) = ℋ ( {t}_{i} , t ) + γ ( t - {t}_{i} ) \\ = ℋ ( {t}_{i} , {t}_{i} ) + γ ( t - 1 - {t}_{i} ) + ε + γ < ( 23 ) \\ 𝒞 ( {t}_{i} , {T}_{0} ) + 𝒞 ( {t}_{i} , {T}_{0} ) + ε + γ ( 24 ) \\ = 2 𝒞 ( {t}_{i} , {T}_{0} ) + ε + γ ( 25 )\end{matrix} \qquad ( 22 )$$

If Tₒ>t, the worst case is that Tₒ=t+1 and [symbol] (tᵢ,T₀)=0 because this is the lowest value pair for both penalties and all other cases would achieve a higher [symbol] (tᵢ,T₀). Thus, the cost of the optimal solution is,

$$\begin{matrix}𝒞 ( {t}_{i} , {T}_{0} ) = 𝒞 ( {t}_{i} t + 1 ) \\ = ℋ ( {t}_{i} , t + 1 ) + γ ( t + 1 - {t}_{i} ) > ( 27 ) \\ \frac{γ ( t - {t}_{i} ) + ℋ ( {t}_{i} , t )}{2} + γ > ( 28 ) \\ \frac{𝒞 ( {t}_{i} , t )}{2} ( 29 )\end{matrix} \qquad ( 26 )$$

Therefore, the cost with respect to the present method, [symbol] (tᵢ, t), will not be more than twice the cost introduced by all other solutions plus a constant, and the present method utilizing the improved online decoder is a two-competitive algorithm.

The improved online decoding method in accordance with the present method can also be shown to be latency-bounded. Firstly, an assumption needs to be made at time t for which the algorithm has not generated the road arc output for a given measurement lᵢ. Since the break-even condition is adopted, then [symbol] (tᵢ,t)>γ(t−tᵢ). In addition, [symbol] is a monotonically decreasing function and t>tᵢ because map matching cannot be performed without receiving the measurement. Hence, [symbol] (tᵢ, t)> [symbol] (tᵢ,tᵢ). By the transitive property of inequalities, it can be obtained that γ(t−tᵢ)< [symbol] (tᵢ,tᵢ). Therefore, the upper-bound of the map matching delay of lᵢ is [symbol] (tᵢ,tᵢ)/γ+tᵢ which is only determined by the characteristic δₜ_{ᵢ}. Thus, an advantage of the present method is that the matching process of every incoming observation can terminate even if the entire measurement input is infinite.

To allow the decoding process to be more efficient, the range of candidate states card(S) in the Hidden Markov model can be narrowed. An exemplary application in accordance with the present embodiment pertains to vehicles. Generally, the current location measurement (except the first one) should not be too far away from the previous location measurement as vehicles usually drive at a limited speed during the time interval between two consecutive samples. As it can be highly possible that all candidate road arcs of the current location observation fall into a small area around the previous sample point, a radial search method to find the candidate road arcs of a location measurement point is used in accordance with the present embodiment instead of using a traditional range query. Thus, the present method can utilize topological information of a road network to radially check each candidate road arc in the vicinity while employing the speed constraints of previous road arcs to limit the search scope.

To evaluate the technical advantages of the present embodiment, it is compared against two alternative prior implementations of the Viterbi algorithm, namely the fixed segment and sliding window methods. Another implementation, a convergence state discovery method, always generates an optimal solution, identical to the offline decoder result in accordance with the present embodiment but does not guarantee any upper bound delay and, therefore, usually involves a long latency (typically on the order of minutes). Hence, that implementation is not applicable to real-time services and has not been considered as a comparative implementation. The evaluation of the present embodiment versus the fixed segment and the sliding window Viterbi algorithm methods utilizes a public real-world dataset collected in Seattle, Wash. USA which includes a relevant road network, GPS trajectory data, and ground truth. The road network comprises more than 150,000 road arcs. The raw GPS trajectory data is a 50-mile route in Seattle which is sampled at 1 Hz and took around two hours to drive, giving 7,531 time-stamped latitude/longitude pairs. The ground truth contains a sequence of road arcs with the directions in which the vehicle actually travelled. Since the exact actual location of the vehicle in the road network corresponding to each GPS sample point is not possible to be determined, only the path taken by the vehicle is viewed as the ground truth. Two evaluation aspects, namely accuracy and latency, are the focus of the evaluation. The underlying Hidden Markov model parameters, σ and β, are also adopted.

In this context, the candidate state space reduction method in accordance with the present embodiment utilizes a radial search method to reduce the set of road arcs and the candidate state size parameter can be set at α=1.8. This leads to the property that only a small set of candidate states eⱼ share the matching probability and the distribution can concentrate more quickly than in the case where the whole road network is used as the candidate set. The information entropy, which is considered as the accuracy penalty proxy in the present method, is calculated for every location measurement in the scope of the whole trip. For each measurement lᵢ, its entropy value changes are recorded and updated when future observations lᵢ₊₁, lᵢ₊₂, . . . , lₙ are received.

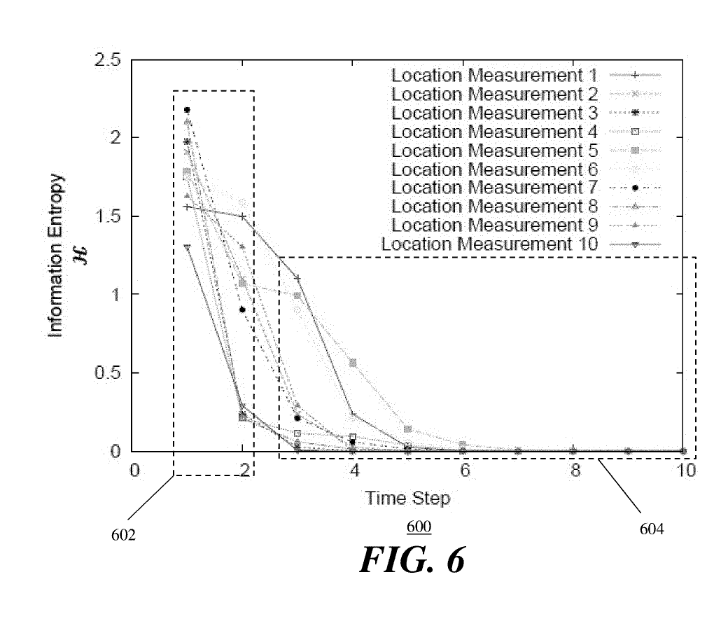

Referring to FIG. 6, a graph 600 depicts example trends of the location measurement's information entropy as time elapses (one new observation received at every time step). The values of entropy function [symbol] is relatively high 602 when only the current measurement is received and no future observation is incorporated into the model. The entropy values 602 indicate the difficulty of generating a matching result immediately. As time increases, [symbol] becomes a monotonically decreasing function 604 which is in accordance with the assumptions described previously.

If the value of [symbol] increases as the time step moves forward for a given lᵢ, the entropy function is not a monotonically decreasing function, and the time step is recorded where the entropy value increases as the increasing point. Among the entire trajectory dataset, 91.53% of the measurements' entropy functions are monotonically decreasing. In addition, 5.52% of the measurements' entropy functions' increasing point appears after receiving more than four hundred future observations in the remaining part of the dataset. Hence, the system is very likely to have already passed the break-even point before seeing such a large number of future observations. In other words, 97.05% of the measurements' entropy functions are actually decreasing if the delay of a system is limited to less than four hundred seconds, which is a reasonable setting in the context of a real-time system. Additionally, if the real-time system only considers future observations within the range of fifty samples, 100% of [symbol] are actually decreasing. This result shows the underlying logic that when more future observations are incorporated into the decoding model, determination of the road which the vehicle is driving on can be more certain.

To illustrate the trade-off between the matching accuracy and the latency, the present embodiment and the fixed segment and sliding window methods are compared with respect to the Seattle trajectory dataset with different γ values and window sizes, co. Different sampling periods are also considered to show the robustness of the embodiment's method under different location measuring rates. The γ value is adjusted from 0.01 to two to tune the trade-off between the road arc mismatch rate and delay time. The parameter ω varies according to the change of the location measurement sampling intervals. For example, in order to obtain an accuracy change from no delay at all to a latency of 120 seconds, the ω value can be tuned from zero to 120 for the fixed sliding window method, and from one to 241 for the fixed segment method, with a sampling period of one second. This is because the fixed segment method can generate labels for all location observations within the current window at once (when the window is full), so that the location measurements in the second half of the window have lower effective latency than the location measurements in the first half. The road arc label of the last location observation in the window is matched and generated by the fixed segment method immediately, without any latency regardless of the window size. Thus, the average effective latency among the observations can be considered within the same window,

$$\frac{ω - 1}{2} \times sampling period ,$$

as the average latency. Similarly, when the sampling period becomes ten seconds, ω value can be from zero to twelve, for fixed sliding window, and from one to twenty-five for fixed segment method, respectively, to compute the mismatch percentage trend from no delay to a latency of 120 seconds. The matching accuracy is measured by a Route Mismatch Fraction (RMF). This fraction is the total length of a false positive route in P and a false negative route in Gₑ divided by the length of the original route. RMF in percentage is reported for each experiment and a higher RMF result indicates more erroneous road arcs are generated by the online map matching algorithm

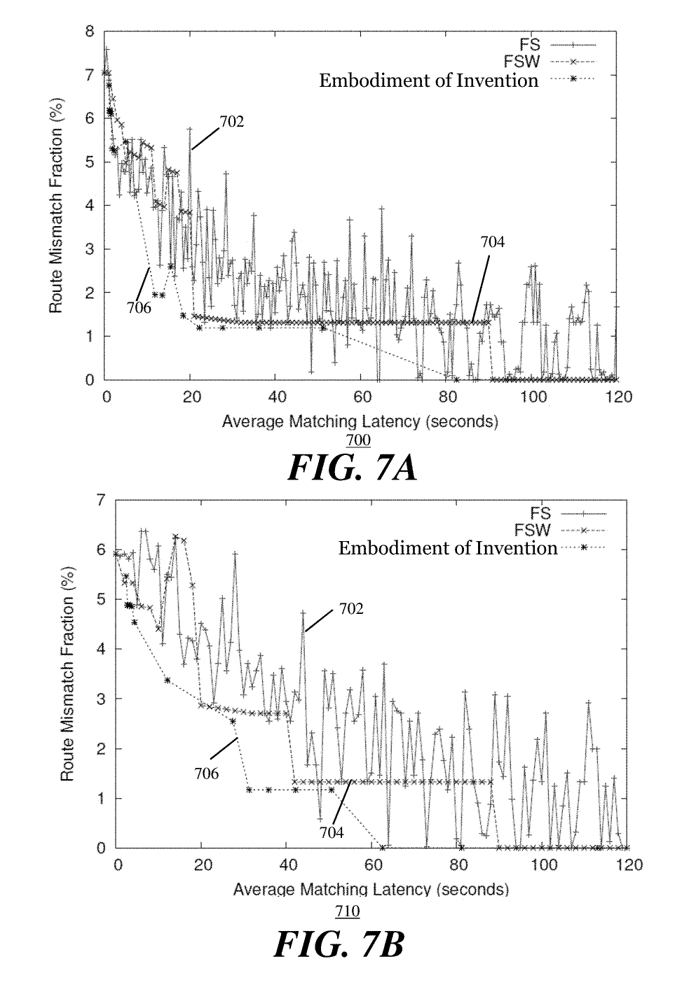

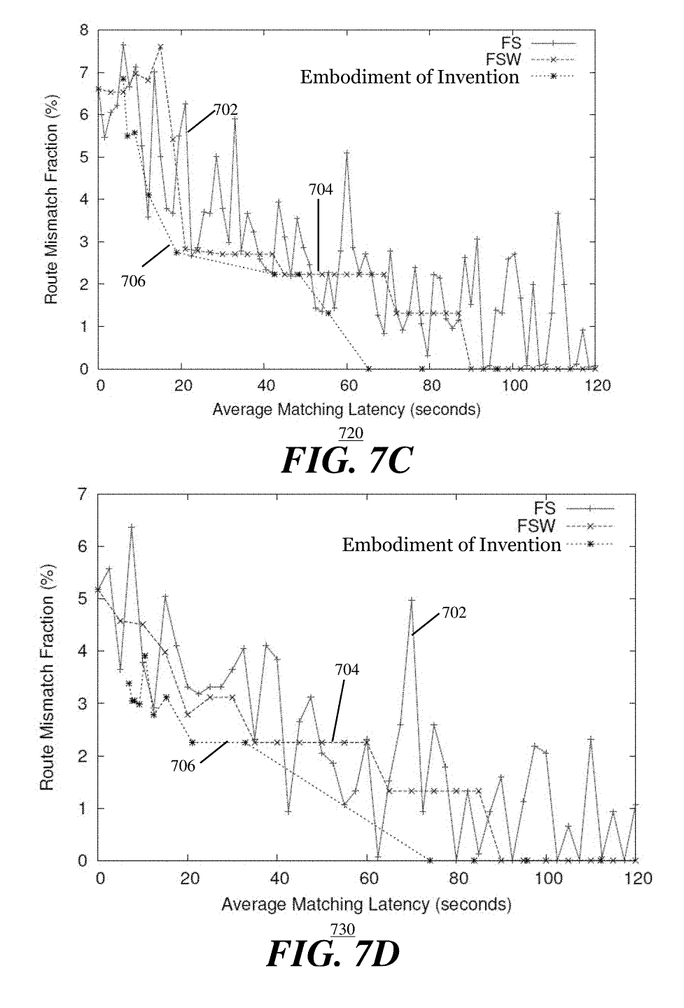

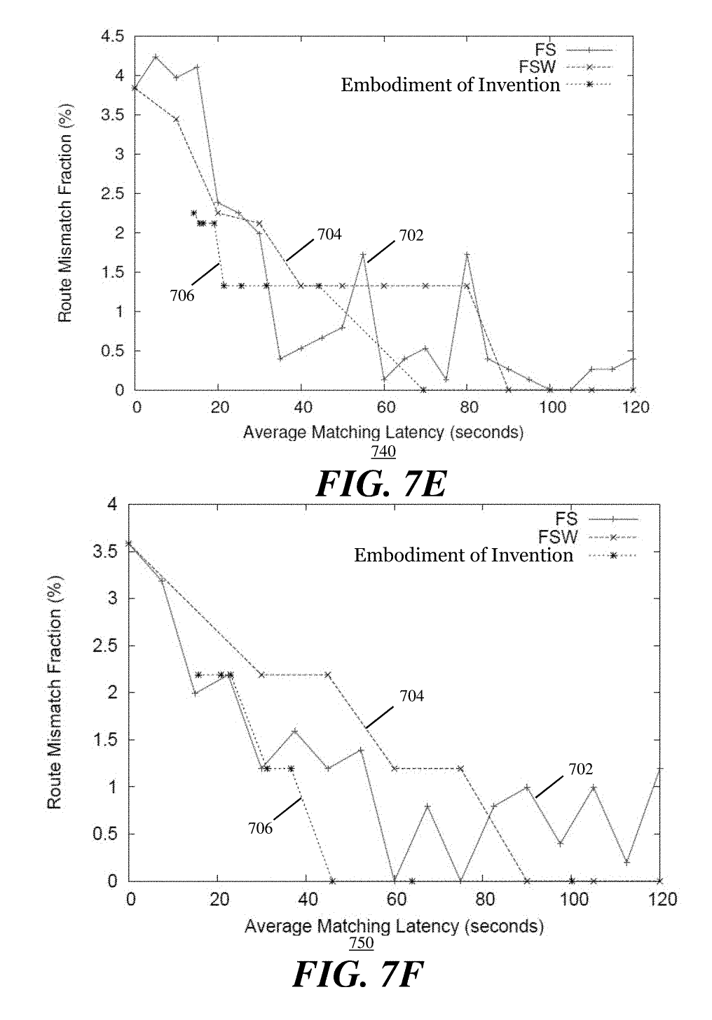

Referring to FIG. 7, comprising FIGS. 7A-7F, graphs 700, 710, 720, 730, 740 and 750 depicts examples of accuracies (in RMF) and latencies (in seconds, from zero to 120 seconds) of the present method with different location measurement sampling intervals, wherein the graph 700 depicts a sampling interval of one observation sample per second, the graph 710 depicts the sampling interval of one observation sample for every two seconds, the graph 720 depicts the sampling interval of one observation sample for every three seconds, the graph 730 depicts the sampling interval of one observation sample for every five seconds, the graph 740 depicts the sampling interval of one observation sample for every ten seconds and the graph 750 depicts the sampling interval of one observation sample for every fifteen seconds. The lines 702, 704, 706 in FIG. 7, represent the accuracy vs latency performance of the fixed segment (FS) method, the fixed sliding window (FSW) method and the present method respectively. Firstly, all figures show an overall declining trend of road arc mismatch fraction as less error results are generated if more future location observations are analysed within the Hidden Markov Model. Second, the output quality of the fixed segment method is much less stable than the other two methods. Although the general trend of the fixed segment method is descending as well, more fluctuations arise when the latency increases. In contrast, the fixed sliding window method and the present method have the advantage that they are more stable, which means the matching results are confidently expected to be more accurate if more future information is provided. Essentially, the plotting lines in all graphs in FIG. 7. representing the present method show that the RMF of the method in according to with the present embodiment is mostly below the fixed segment method and the fixed sliding window method for the same average matching latency. Similarly, this also means that the present method can advantageously achieve the shortest latencies with the same accuracy constraints. Moreover, the RMF value of the present method settles to zero much earlier than either the fixed segment method or the fixed sliding window method under different sampling rates. This means that the method in accordance with the present embodiment can advantageously achieve a stable 100% accuracy of the road arc generation results with a much shorter latency.

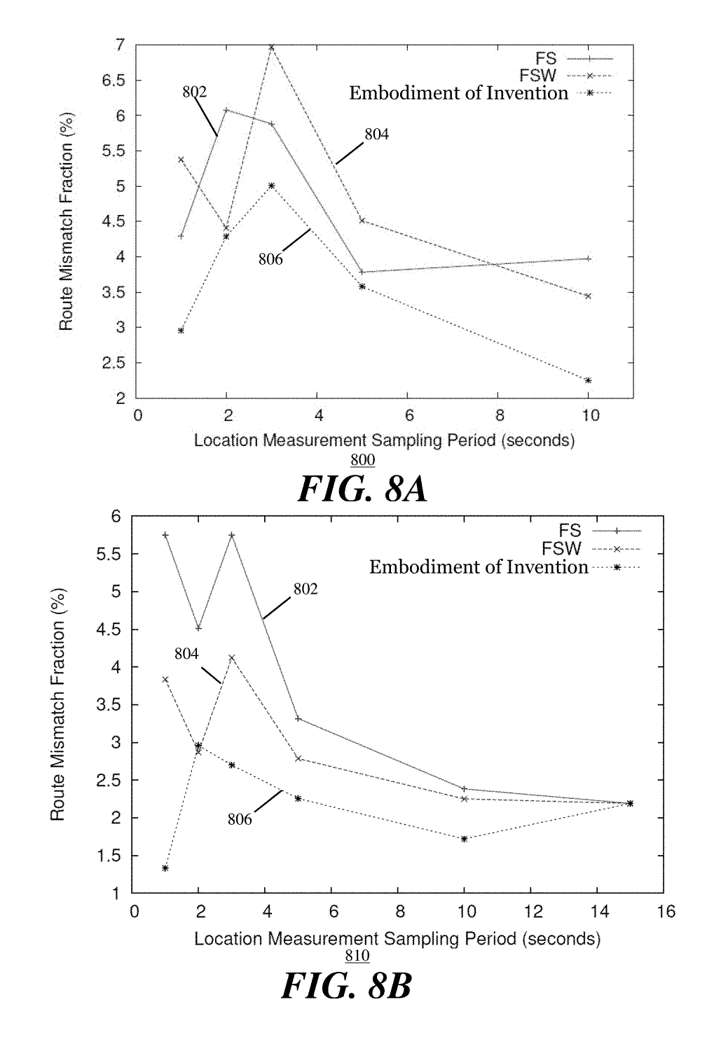

Referring to FIG. 8, comprising FIGS. 8A-8B, graphs 800 and 810 depict examples of the accuracy of the present method with different location measurement sampling intervals wherein the graph 800 depicts measurement sampling intervals under a fixed latency constraint of ten seconds and the graph 810 depicts measurement sampling intervals under a fixed latency constraint of fifteen seconds, illustrating the online map matching accuracy improvements. The lines 802, 804 and 806 in FIG. 8, represent the accuracy vs latency performance of the fixed segment (FS) method, the fixed sliding window (FSW) method and the present method, respectively. The plotting lines in all graphs in FIG. 8 representing the present method prove that the route mismatch fraction in accordance with the present method is substantially below the fixed segment method and the fixed sliding window method for the same location sampling period. This means that the present method (i.e., the method in accordance with the present embodiment) advantageously generates less error.

Thus, the present embodiment combining a real time Hidden Markov Model-based map matching method with an improved online Viterbi decoding approach provides an optimal solution to minimize the trade-off between selection latency and selection accuracy. This advantageous method minimizes the trade-off between selection latency and selection accuracy resulting in a stable 100% accurate road arc generation with a much shorter latency and is, advantageously, also capable of dynamically selecting the window size according to characteristics of the candidate state probability distribution. While exemplary inventions have been presented in the foregoing detailed description of the embodiments, it should be appreciated that a vast number of variations exist.

It should further be appreciated that the exemplary inventions are only examples, and are not intended to limit the scope, applicability, operation, or configuration of the embodiments in any way. Rather, the foregoing detailed description will provide those skilled in the art with a convenient road map for implementing an exemplary embodiments of the embodiments, it being understood that various changes may be made in the function and arrangement of elements and method of operation described in an exemplary embodiments without departing from the scope of the embodiments as set forth in the appended claims.

What is claimed is:

1. A method for map matching, comprising:
modelling each road arc as a hidden state and each location measurement as an observation emitted by the hidden state using a Hidden Markov Model;
decoding each road arc and each location measurement using a Viterbi algorithm; and
outputting a matching road arc,
wherein the outputting is delayed by a delay time determined in response to an optimal tradeoff between selection accuracy and selection latency.

2. The method in accordance with claim 1 wherein the modelling step comprises:
narrowing a set of candidate road arcs to generate a reduced set of candidate road arcs;
modelling each road arc in the reduced set of candidate road arcs as the hidden state and each location measurement as the observation emitted by the hidden state using the Hidden Markov Model; and
decoding each road arc in the reduced set of candidate road arcs and each location measurement using a Viterbi algorithm.

3. The method in accordance with claim 1, wherein the delay time is selected by minimizing a function of the selection accuracy and the selection latency, the selection accuracy being a decreasing function of the delay time and the selection latency being an increasing function of the delay time.

4. The method in accordance with claim 3, wherein the selection accuracy is determined by an information entropy of a probability distribution which indicates the likelihood of each road arc being the matching road arc.

5. The method in accordance with claim 3, wherein the selection latency is determined by a function of a tradeoff parameter and the delay time.

6. The method in accordance with claim 5, wherein the tradeoff parameter is predetermined.

7. The method in accordance with claim 3, wherein the delay time is determined when the selection accuracy is equal to or less than the selection latency.

8. A device for map matching, comprising
a location data receiving device;
a memory having road arcs in a road network stored therein;
a user interface including a user presentation device; and
a processor coupled to the location data receiving device, the memory, and the user interface, the processor being configured to:
model each of the road arcs stored in the memory as a hidden state and each location measurement detected by the location data receiving device as an observation emitted by the hidden state using a Hidden Markov Model;
decode each of the road arcs and each location measurement using a Viterbi algorithm; and
output a matching road arc to the user presentation device,
wherein the output is delayed by a delay time determined in response to an optimal tradeoff between selection accuracy and selection latency.

9. The device in accordance with claim 8, wherein the processor is configured to select the delay time by minimizing a function of the selection accuracy and the selection latency, the selection accuracy being a decreasing function of the delay time and the selection latency being an increasing function of the delay time.

10. The device in accordance with claim 9, wherein the processor is configured to determine the selection accuracy in response to an information entropy of a probability distribution which indicates the likelihood of each road arc being the matching road arc.

11. The device in accordance with claim 9, wherein the processor is configured to determine the selection latency by a function of a tradeoff parameter and the delay time.

12. The device in accordance with claim 11, wherein the tradeoff parameter is predetermined.

13. The device in accordance with claim 9, wherein the processor is configured to determine the delay time when the selection accuracy is equal to or less than the selection latency.

14. The device in accordance with claim 8 wherein the processor is configured to model each of the road arcs and each location measurement by narrowing a set of candidate road arcs to generate a reduced set of candidate road arcs and modelling each road arc in the reduced set candidate road arcs as the hidden state and each location measurement as the observation emitted by the hidden state using the Hidden Markov Model.
